(19) United States
(12) Patent Application Publication
(10) Pub. No.: US 2015/0273666 A1
(43) Pub. Date: Oct. 1, 2015

(54) WRENCH

(71) Applicant: Jun-Fan CHEN, Taichung City (TW)

(72) Inventor: Jun-Fan CHEN, Taichung City (TW)

(21) Appl. No.: 14/228,138

(22) Filed: Mar. 27, 2014

(51) Int. Cl. B25B 13/16; B25B 13/48

(52) U.S. Cl. CPC B25B 13/16; B25B 13/481

(57) ABSTRACT

The wrench includes a main body, two clamping members, a sliding member, two connecting arms, and a rotation member. The main body has two extending arms and a threaded rod section wherein each extending arm is formed with a sliding groove. Each clamping member has a channel for sleeving onto the extending arm so as to be movable along the extending arm. Two ends of each connecting arm are pivotably connected with the sliding member and the clamping member. A pivot pin penetrates the clamping member and the sliding groove and is slidable in the sliding groove. The rotation member is rotatably disposed on the sliding member with an end. The rotation member is screwed with the threaded rod section. The two clamping members move toward each other or leave each other when the rotation is rotated with respect to the threaded rod section.

### BACKGROUND OF THE INVENTION

1. Field of the Invention

The present invention relates to a wrench, more especially to a wrench whose clamping width is adjustable.

2. Description of the Prior Art

Conventional automobile tools for using in narrow spaces usually have clamping spaces whose sizes are not adjustable. Thus, it is inconvenient and costly that plural tools in various sizes should be prepared.

On the other hand, there are still tools such as wrenches having adjustable clamping spaces. Most of the tools have a fixed jaw and a movable jaw which is movable with respect to the fixed jaw. By moving the movable jaw, the size of clamping space can be adjusted. However, the adjusting mechanism is located at the head of the tool and is difficult to operate by users when the tool is placed into a narrow space. Thus, efficiency of work is reduced.

### SUMMARY OF THE INVENTION

The main object of the present invention is to provide a wrench whose clamping width is adjustable.

To achieve the above and other objects, a wrench of the present invention includes a main body, two clamping members, a sleeve member, and two connecting arms.

The main body defines an axial direction. The main body has a first end and an opposite second end. The main body has two extending arms extending outward from the first end. The two extending arms extend oppositely and obliquely. The main body has a gripping portion. The main body further has a screwing mechanism between the first end and the second end.

Each clamping member is slidably disposed one of the extending arms. Each clamping member is formed with a clamping portion on a face thereof facing the other clamping member. A clamp width is defined as a distance between the two clamping portions.

The sleeve member is screwed with the screwing mechanism of the main body. The sleeve member moves with respect to the screwing mechanism along the axial direction when the sleeve member is rotated with respect to the screwing mechanism.

An end of each connecting arm is pivotably connected with one of the clamping members, and an opposite end of the connecting arm is pivotably connected with one of the sleeve member and the screwing mechanism.

When the sleeve member is moved with respect to the screwing mechanism, an end of each connecting arm is moved along the axial direction to further drive the two clamping members to slide on the two arms respectively so as to alternate the clamp width.

More practically, the present invention also provides a wrench includes a main body, two clamping members, a sliding member, two connecting arms, and a rotation member.

The main body defines an axial direction. The main body has a first end and an opposite second end. The main body has two extending arms extending outward from the first end. The two extending arms extend oppositely and obliquely. The main body has a gripping portion at the second end. The main body is formed with a threaded rod section between the first end and the second end.

Each clamping member is slidably connected with one of the connecting arms. Each clamping member is formed with a clamping portion on a face thereof facing the other clamping member. A clamp width is defined as a distance between the two clamping portions.

The sliding member is sleeved onto the threaded rod section of the main body. The sliding member is slidable along a longitudinal direction of the threaded rod section.

Two opposite ends of each connecting arm being pivotably connected with the sliding member and one of the clamping members.

The rotation member is rotatably connected to the sliding member. The rotation member has inner threads to screw with the threaded rod section of the main body.

When the rotation member is rotated with respect to the threaded rod section to be moved toward the gripping portion along the threaded rod section, the sliding member and the two connecting arms are moved toward the gripping portion driving by the rotation member. Thereby the two connecting arms drive the two clamping members to move toward each other so as to reduce the clamp width.

When the rotation member is rotated with respect to the threaded rod section to be moved opposite to the gripping portion along the threaded rod section, the sliding member and the two connecting arms are moved opposite to the gripping portion driving by the rotation member. Thereby the two connecting arms drive the two clamping members to move away from each other so as to expand the clamp width.

Thus, the clamp width of the wrench can be easily adjusted, and the wrench of the present invention is able to be used in narrow spaces.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is an illustration of the present invention when the clamp width is increasing;

FIG. 4 is an illustration of the present invention when the clamp width is reducing.

### DETAILED DESCRIPTION OF THE PREFERRED EMBODIMENTS

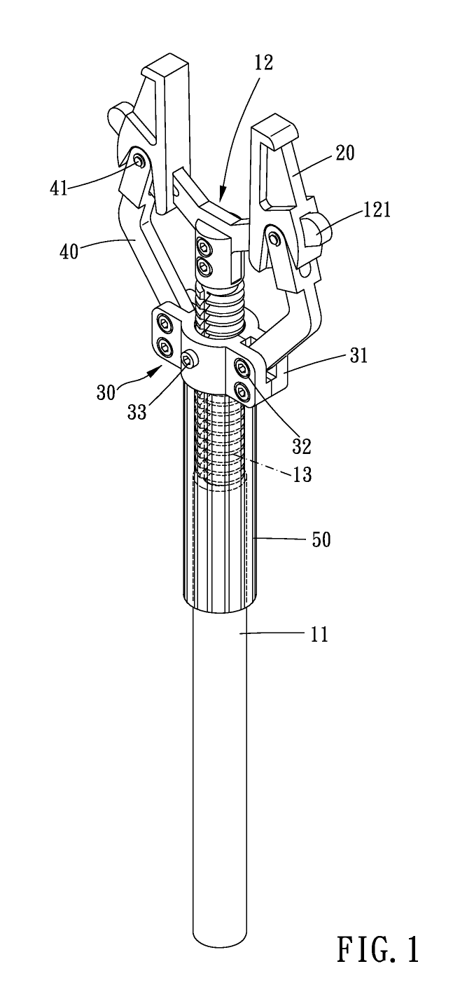

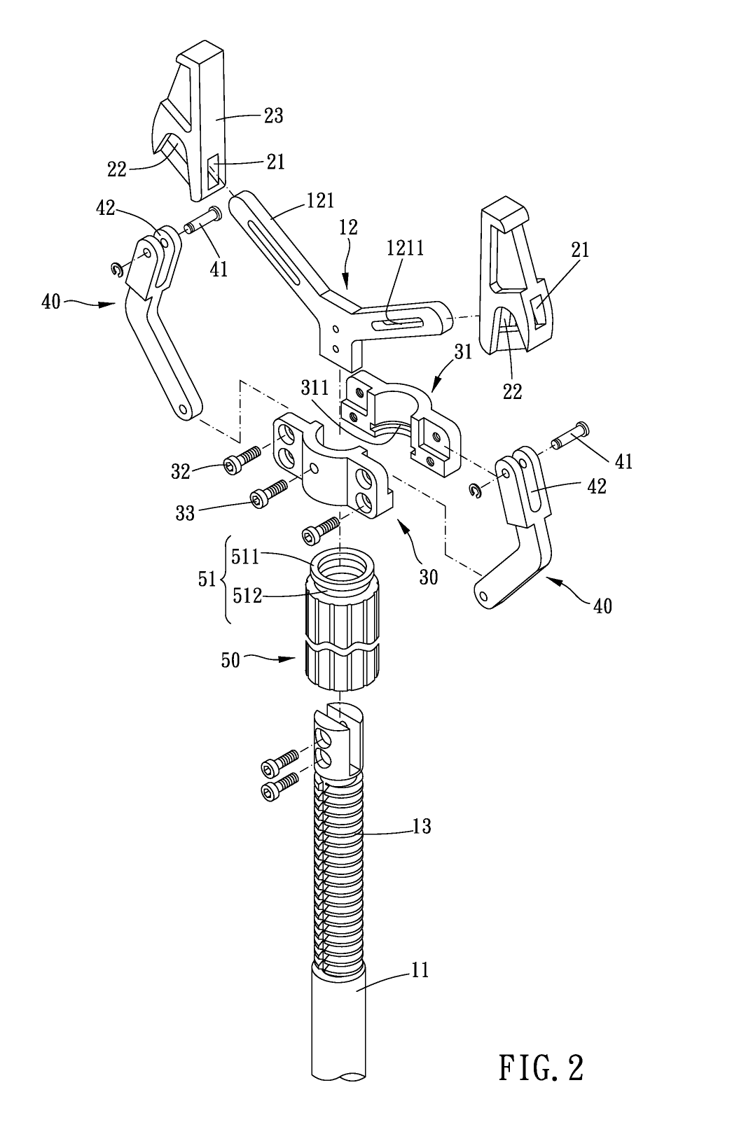

Please refer to FIG. 1 to FIG. 4, the wrench of the present embodiment includes a main body, two clamping members 20, a sliding member 30, two connecting arms 40, and a rotation member 50.

The main body defines an axial direction and has a first end and an opposite second end. The main body has a Y-shaped portion 12 at the first end and a gripping portion 11 at the second end. The Y-shaped portion 12 includes two extending arms 121 extending outward from the main body. The main body further has a threaded rod section 13 between the Y-shaped portion 12 and the gripping portion 11. In the present embodiment, the Y-shaped portion 12 and the threaded rod section 13 are manufactured separately and independently, and the Y-shaped portion 12 is positioned to an end of the threaded rod section 13 remote from the gripping portion 11 after the sliding member 30 and the rotation member 50 have been sleeved onto the threaded rod section 13. Besides, each extending arm 121 is formed with a sliding groove 1211 extending a predetermined distance along a longitudinal direction of the extending arm 121. More specifically, each extending arm 121 obliquely extends opposite to the threaded rod section 13, and an angle between each extending arm 121 and the threaded rod section 13 is larger than 90 degrees. A direction defined by two openings of the sliding groove 1211 is perpendicular to the axial direction of the main body and also to the longitudinal direction of the extending arm 121.

Each clamping member 20 is formed with a channel 21 having an internal contour corresponding to a shape of one of the extending arm 121. The two clamping members 20 are sleeved onto the two extending arms 121 respectively by making the two extending arms 121 insert into the channels 21 so that each clamping member 20 is slidable along the longitudinal direction of the extending arm 121. Each clamping member 20 is formed with a through hole 22 traversing the channel 21. Each clamping member 20 has a clamping portion 23 on a face thereof facing the other clamping member 20. A clamp width is defined as a distance between the two clamping portions 23. In the present embodiment, the clamping portion 23 is a flat surface parallel to the axial direction. That is, the two clamping portions 23 are parallel to each other.

The sliding member 30 is sleeved onto the threaded rod section 13 and is slidable along the longitudinal direction of the threaded rod section 13. An end of each connecting arm 40 is pivotally connected with the sliding member 30, and an opposite end of the connecting arm 40 is pivotally connected with the clamping member 20 by a pivot pin 41 inserting through the through hole 22 of the clamping member 20. The pivot pin 41 is slidable in the sliding groove 121. An end of the rotation member 50 is rotatably disposed on an end of the sliding member 30 remote from the Y-shaped portion 12. The rotation member 50 has inner threads to screw with the threaded rod section 13. Preferably, the rotation member 50 covers part of the gripping portion 11. That is, the rotation member 50 covers the whole lower portion of the threaded rod section 50. Besides, the rotation member 50 is formed with knurling patterns on an outer surface thereof for gripping.

In the present embodiment, the sliding member 30 includes two fastening elements 31. The threaded rod section 31 is sandwiched by the two fastening elements 31 therebetween. In other words, a clamping space is enclosed by the two fastening elements 31, and the threaded rod section 31 is inserted through the clamping space. Each connecting arm 40 is sandwiched by the two fastening elements 31, and the two connecting arms 40 are located at two opposite sides of the threaded rod section 13 respectively. A pivot element 32 penetrates the two fastening elements 31 and one of the connecting arms 40 so that the connecting arm 40 is pivotable with respect to the two fastening elements 31 around the pivot element 32. Besides, each connecting arm 40 is bent to have a recessed portion facing the Y-shaped portion 12 and a protruded portion opposite to the Y-shaped portion 12. Each connecting arm 40 has a trough 42 at an end connecting with the clamping member 20. The clamping member 20 is received in the trough 42. The pivot pin 41 penetrates two opposite side walls of the trough 42 and the through hole 22 of the clamping member 20 so that the connecting arm 40 is pivotally connected with the clamping member 20.

Furthermore, each fastening element 31 is formed with an annular groove 311 on a face thereof facing the other fastening element 31 wherein the annular groove 311 extends around the axial direction. The rotation member 50 has a restriction portion 51 at an end thereof near the sliding member 40. The restriction portion 51 includes an expanded section 511 and a reduced section 512 wherein the expanded section 511 is closer to the sliding member 30 than the reduced section 512. The expanded section 511 has an external diameter larger than an external diameter of the reduced section 512 but smaller than an external diameter of the rotation member 50 except the restriction portion 51. The expanded section 511 is received in the two annular grooves 311 so that the rotation member 50 is rotatably disposed on the sliding member 30 and is unable to be separated from the sliding member 30. The sliding member 30 and the rotation member 50 move as a single piece along the axial direction.

The sliding member 30 further includes a positioning element 33. The positioning element 33 penetrates one of the fastening members 31 and alternatively abuts against the root of the threaded rod section 13 so that the sliding member 30 is unable to move along the threaded rod section 13. Thereby, the rotation member 50 is prevented from rotating by fastening the positioning element 33. The sliding member optionally includes at least one fixing bolt inserted through threaded holes of the two fastening elements to fasten the two fastening elements so as to adjust the ability of pivoting of the two connecting arms with respect to the sliding member.

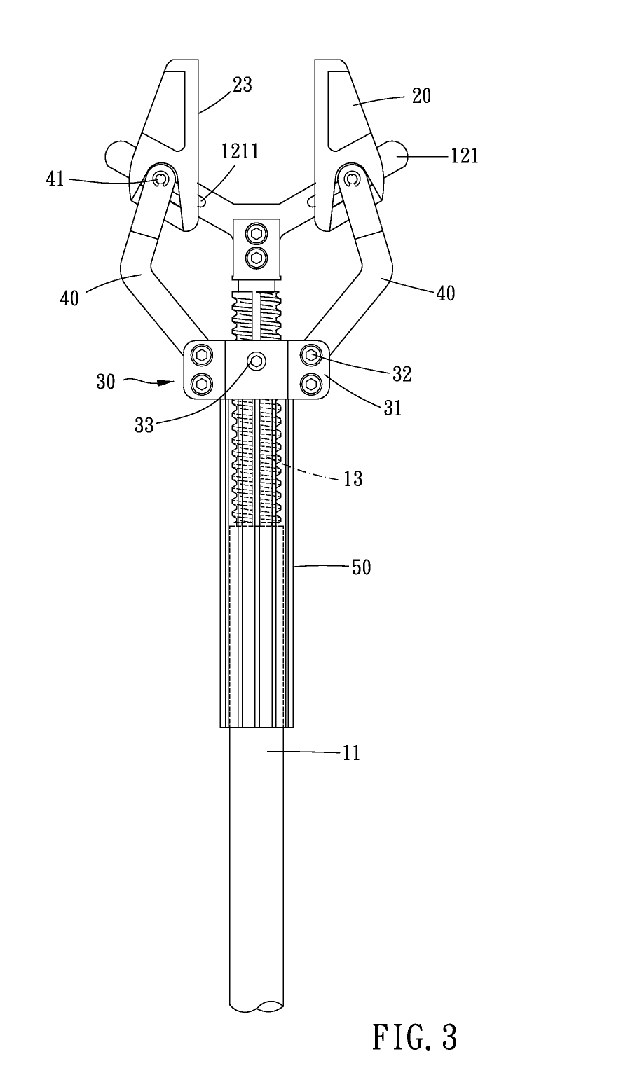

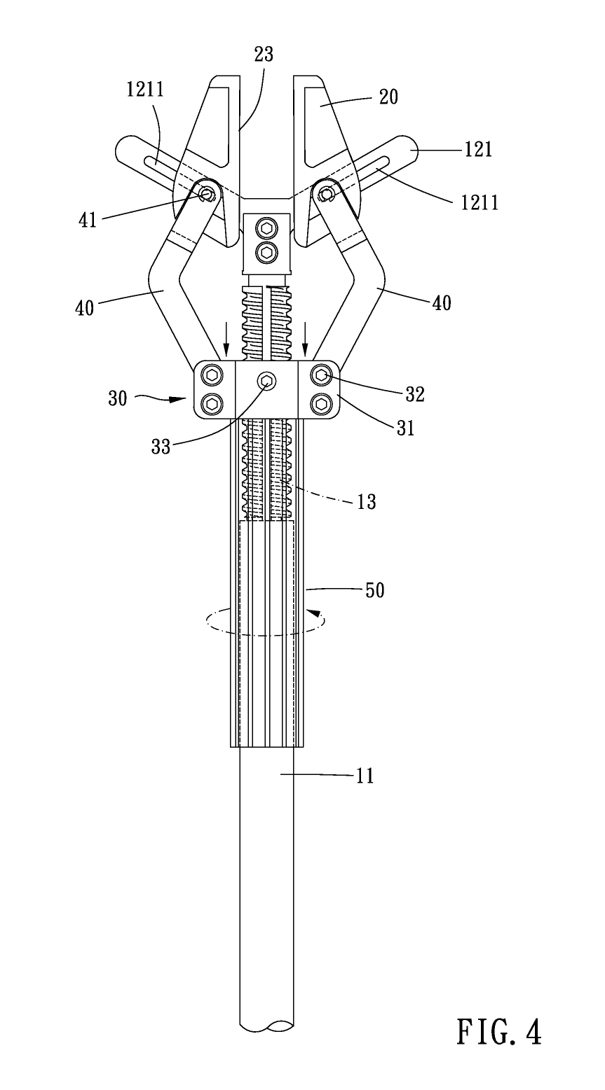

In use, please refer to FIG. 3 and FIG. 4, a toolpiece can be clamped by the two clamping members 20 and be rotated by pulling the gripping portion 11. The clamp width can be adjusted by rotating the rotation member 50 to fit the size of the toolpiece to separate or close the two clamping members 20. More specifically, when the clamp width is to be expanded, the rotation member 50 should be moved upward by rotating the rotation member 50 to lift the sliding member 30 and the two connecting arms 40 up. Because the two extending arms 121 extend upward obliquely, the upward-moving connecting arms 40 drive the clamping members 20 to move toward the free ends of the extending arms 121. That is, the two clamping members 20 are moved away from each other to expand the clamp width. On the contrary, when the clamp width is to be reduced, the rotation member 50 should be lowered along the threaded rod section 13 by rotating the rotation member 50 so as to drive the sliding member 30 and the two connecting arms 40 to move downward. Thereby, the downward-moving connecting arms 40 drive the clamping members 20 to move toward the main body along the extending arms 121 so as to reduce the clamp width. Besides, each sliding groove 1211 has a predetermined length, so each clamping member 20 moves along the extending arm 121 limitedly. Thus, the clamping members 20 are prevented from separating from the extending arms 121.

Besides, the two clamping members 20 both move along straight lines, so the two clamping portions 23 are kept parallel to each other. Thus, the clamping portions 23 can clamp the toolpiece evenly. On the other hand, the two clamping members 20 are sleeved onto the extending arms 121 so that the torque born by the clamping portions 23 may not be transmitted to the connecting arms 40, the sliding member 30, and the rotation member 50 to prevent the components from damaging.

What is claimed is:

1. A wrench, comprising:
a main body, defining an axial direction, the main body having a first end and an opposite second end, the main body having two extending arms extending outward from the first end, the two extending arms extending oppositely and obliquely, the main body having a gripping portion at the second end, the main body further having a screwing mechanism between the first end and the second end;
two clamping members, each clamping member being slidably disposed one of the extending arms, each clamping member being formed with a clamping portion on a face thereof facing the other clamping member, a clamp width being defined as a distance between the two clamping portions;
a sleeve member, screwed with the screwing mechanism of the main body, the sleeve member moving with respect to the screwing mechanism along the axial direction when the sleeve member is rotated with respect to the screwing mechanism;
two connecting arms, an end of each connecting arm being pivotably connected with one of the clamping members, an opposite end of the connecting arm being pivotably connected with one of the sleeve member and the screwing mechanism;
wherein an end of each connecting arm is moved along the axial direction to further drive the two clamping members to slide on the two arms respectively so as to alternate the clamp width when the sleeve member is moved with respect to the screwing mechanism.

2. A wrench, comprising:
a main body, defining an axial direction, the main body having a first end and an opposite second end, the main body having two extending arms extending outward from the first end, the two extending arms extending oppositely and obliquely, the main body having a gripping portion at the second end, the main body being formed with a threaded rod section between the first end and the second end;
two clamping members, each clamping member being slidably connected with one of the connecting arms, each clamping member being formed with a clamping portion on a face thereof facing the other clamping member, a clamp width being defined as a distance between the two clamping portions;
a sliding member, sleeved onto the threaded rod section of the main body, the sliding member being slidable along a longitudinal direction of the threaded rod section;
two connecting arms, two opposite ends of each connecting arm being pivotably connected with the sliding member and one of the clamping members;
a rotation member, rotatably connected to the sliding member, the rotation member having inner threads to screw with the threaded rod section of the main body;
wherein when the rotation member is rotated with respect to the threaded rod section to be moved toward the gripping portion along the threaded rod section, the sliding member and the two connecting arms are moved toward the gripping portion driving by the rotation member, thereby the two connecting arms drive the two clamping members to move toward each other so as to reduce the clamp width;
wherein when the rotation member is rotated with respect to the threaded rod section to be moved opposite to the gripping portion along the threaded rod section, the sliding member and the two connecting arms are moved opposite to the gripping portion driving by the rotation member, thereby the two connecting arms drive the two clamping members to move away from each other so as to expand the clamp width.

3. The wrench of claim 2, wherein the main body has a Y-shaped portion at the first end, the Y-shaped portion includes the two extending arms, the two extending arms extend outward from the main body to form the Y-shaped portion, each extending arm is formed with a sliding groove, each sliding groove extending along a longitudinal direction of the extending arm, each clamping member is formed with a channel, the two clamping members are sleeved onto the two extending arms by making the extending arms penetrate through the channels so that the clamping members are slidable along the longitudinal directions of the extending arms respectively, each clamping member is formed with a through hole traversing the channel, an end of each connecting arm is pivotably disposed on the sliding member, an opposite end of each connecting arm is pivotably disposed on the clamping member by a pivot pin inserted through the through hole and the sliding groove wherein the pivot pin is slidable in the sliding groove.

4. The wrench of claim 2, wherein an angle between each extending arm and the threaded rod section is larger than 90 degrees.

5. The wrench of claim 2, wherein the two clamping portions are parallel to each other.

6. The wrench of claim 3, wherein each connecting arm has a trough at an end thereof connecting with the clamping member, the clamping member is received in the trough, the pivot pin penetrates two opposite side walls of the trough and the through hole of the clamping member.

7. The wrench of claim 2, wherein the sliding member includes two fastening elements, the threaded rod section of the main body is sandwiched by the two fastening elements therebetween, a pivot element penetrates the two fastening elements and the connecting arm, each fastening element is formed with an annular groove on a face thereof facing the other fastening element, the rotation member has a restriction portion at an end near the sliding member, the restriction portion includes an expanded section and a reduced section, the expanded section is closer to the sliding member than the reduced section, the expanded section has an external diameter larger than an external diameter of the reduced section but smaller than an external diameter of the rotation member except the restriction portion, the expanded section is received in the two annular groove so that the rotation member is rotatably disposed on the sliding member.

8. The wrench of claim 7, wherein the sliding member further includes a positioning element, the positioning element penetrates one of the fastening element and alternatively abuts against a root of the threaded rod section to prohibit the sliding member from moving along the threaded rod section.

9. The wrench of claim 2, wherein the rotation member covers part of the gripping portion.

10. The wrench of claim 2, wherein the rotation member is formed with knurling patterns on an outer surface thereof.

11. The wrench of claim 3, wherein each connecting arm is bent to form a recessed portion facing the Y-shaped portion and a protruded portion opposite to the Y-shaped portion.
